(19) United States
(12) Patent Application Publication
(10) Pub. No.: US 2022/0001464 A1
(43) Pub. Date: Jan. 6, 2022

(54) METHOD OF PRODUCING DRILL

(71) Applicant: DENSO CORPORATION, Kariya-city (JP)

(72) Inventors: Akihiro UEDA, Kariya-city (JP); Naoki SUMIYA, Kariya-city (JP); Shota INABA, Kariya-city (JP)

(21) Appl. No.: 17/481,450

(22) Filed: Sep. 22, 2021

Related U.S. Application Data
(63) Continuation of application No. PCT/JP2020/008004, filed on Feb. 27, 2020.

(30) Foreign Application Priority Data
Mar. 25, 2019 (JP) 2019-056939

(51) Int. Cl. B23B 51/02

(52) U.S. Cl. CPC B23B 51/02; B23B 2251/40; B23B 2251/14

(57) ABSTRACT

A method of producing a drill has a step of preparing a workpiece to be processed to produce a drill, and a step of forming a ground groove. The workpiece has a cutting blade, a chip discharge flute helically extending, and a rake surface which have been formed therein. The drill is rotated around a drill axial center. The formation step rotates a rotary whetstone around its whetstone axial center, and grinds the rake surface to form the ground groove along the chip discharge flute. The formation step uses the rotary whetstone so that the whetstone axial center intersects a longitudinal direction of the chip discharge flute. The rotary whetstone has a rotating body shape projecting in a radial outward direction of the rotary whetstone axial center and around the rotary whetstone axial center.

### CROSS-REFERENCE OF RELATED APPLICATION

This application is related to and claims priority from Japanese Patent Application No. 2019-56939 filed on Mar. 25, 2019, the contents of which are hereby incorporated by reference.

### TECHNICAL FIELD

The present disclosure relates to methods of producing a drill.

### BACKGROUND ART

There is a cutting tool with a cutting edge formed at a tip end thereof, and a rake surface of the cutting tool has a waviness formed by a laser machining.

A technique is desired which is capable of smoothly discharging chips generated in a drill cutting process without chips clogging the chip discharge flutes, where the chip discharge flutes have a helical and concave shape and are formed on the drill. In order to smoothly discharge chips through the chip discharge flutes of the drill, the inventors have proposed a drill structure in which guide grooves are formed on a rake surface, extending from a cutting edge of the drill along the chip discharge flute.

However, because the area around the rake surface in the drill has a complicated shape, it is necessary to avoid physical interference between the drill and a processing tool from occurring during the guide groove formation performed by a machining process such as a griding process and a cutting process. Although it is possible for a laser machining process to form guide grooves, as disclosed in patent document 1, thermal energy generated by the laser machining process easily causes strength reduction of the drill. This strength reduction reduces the lifetime of the drill. After deep consideration, the inventors of the present disclosure have discovered the following matters.

### SUMMARY

It is desired for the present disclosure to provide a method of producing a drill. The drill has a drill main body. The drill main body has a chip discharge flute, a rake surface and a cutting blade. A tip end is formed at a first side in an axial direction of a drill axial center of the drill main body. The drill is rotated around the drill axial center. The drill main body is formed extending in a direction of the axial direction. The cutting blade is formed at the tip end side of the drill main body. The chip discharge flute has a helical shape and formed on the drill main body. The chip discharge flute is formed helically extending from the tip end side of the drill main body toward a rear end side of the drill main body. The rake surface is formed, facing the chip discharge flute, at the tip end side of the drill main body. The rake surface is formed extending from the cutting blade along the chip discharge flute. The method has a preparing step, and a groove formation step. The preparing process prepares a workpiece, to be processed to produce the drill, on which the cutting blade, the chip discharge flute and the rake surface have been formed. The groove formation step forms a ground groove on the rake surface by grinding the rake surface, in a direction extending along the chip discharge flute by using a rotary whetstone. The rotary whetstone rotates around a rotary whetstone axial center thereof. The groove formation step uses the rotary whetstone. The rotary whetstone axial center of the rotary whetstone is arranged to intersect a longitudinal direction of the ground groove. The rotary whetstone has a rotating body shape projecting in a radial outward direction of the rotary whetstone axial center and around the rotary whetstone axial center.

### BRIEF DESCRIPTION OF DRAWINGS

FIG. 1 shows an entire structure of a drill in a first embodiment of the present disclosure.

FIG. 2 shows a schematic cross section along the line II-II shown in FIG. 1. FIG. 3 is an enlarged schematic view of an area III shown in FIG. 1.

FIG. 4 shows a cross section of a plurality of guide grooves and a surrounding part thereof in a cross section IV-IV shown in FIG. 3.

FIG. 5 shows a flow chart of a method of producing a drill for forming the plurality of guide grooves on a rake surface of the drill, i.e. for producing the drill with the plurality of guide grooves formed on the rake surface of the drill according to the first embodiment of the present disclosure.

FIG. 6 shows a positional relationship between a workpiece and a rotary whetstone which rotates in a groove formation process shown in FIG. 5 in the method according to the first embodiment, and shows a crossing angle between an axial center of the drill and an axial center of the rotary whetstone.

FIG. 7 shows a cross section of a schematic structure of the rotary whetstone to be used in the groove formation process shown in FIG. 5 in the method according to the first embodiment.

FIG. 8 is a perspective view showing a moving direction of the workpiece to be ground in the groove formation process shown in FIG. 5 in the method according to the first embodiment.

FIG. 9 shows a positional relationship between the workpiece and the rotary whetstone in the groove formation process shown in FIG. 5 in the method according to a second embodiment, corresponding to the view shown in FIG. 6.

FIG. 10 shows a cross section of a schematic structure of the rotary whetstone to be used in the groove formation process shown in FIG. 5 in the method according to the second embodiment, corresponding to the view shown in FIG. 7.

FIG. 11 is a perspective view showing a moving direction of the workpiece to be ground in the groove formation process shown in FIG. 5 in the method according to the second embodiment, corresponding to the view shown in FIG. 8.

FIG. 12 is a perspective view showing a moving direction of the workpiece to be ground in the groove formation process shown in FIG. 5 in the method according to a third embodiment, corresponding to the view shown in FIG. 8.

FIG. 13 shows a cross section of a schematic structure of the rotary whetstone to be used in the groove formation process shown in FIG. 5 in the method according to another embodiment, corresponding to the view shown in FIG. 7.

### DETAILED DESCRIPTION OF THE PREFERRED EMBODIMENTS

Hereinafter, various embodiments of the present disclosure will be described with reference to the accompanying drawings. In the following description of the various embodiments, like reference characters or numerals designate like or equivalent component parts throughout the several diagrams.

Next, a description will be given of a method of producing a drill according to preferred embodiments of the present disclosure.

### First Embodiment

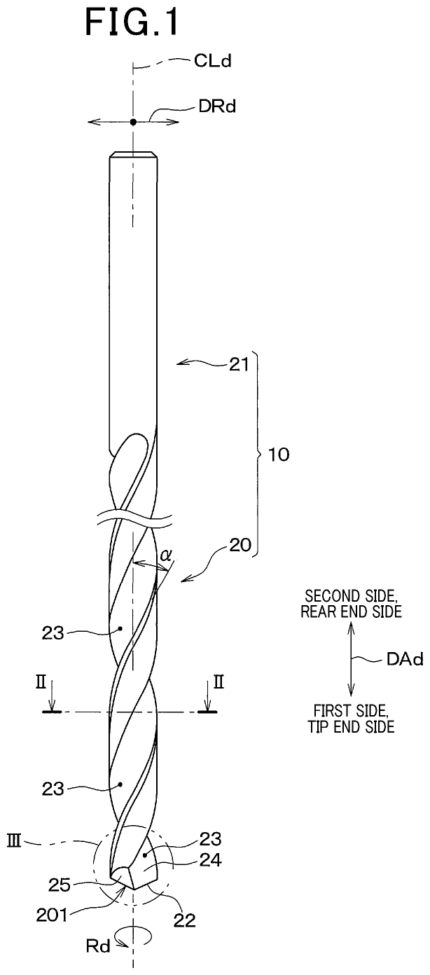

As shown in FIG. 1, the first embodiment of the present disclosure shows a drill 10 as a cutting tool. A cutting process (in more detail, when drilling a hole) uses the drill 10, which drills a workpiece by turning it around a drill axial center CLd thereof. The drill 10 has a shaft shape extending in an axial direction DAd of the drill axial center CLd. The drill 10 consists of a drill main body 20 and a shank 21. The drill main body 20 is joined in series to the shank 21 at a first side of the axial direction DAd of the drill axial center CLd.

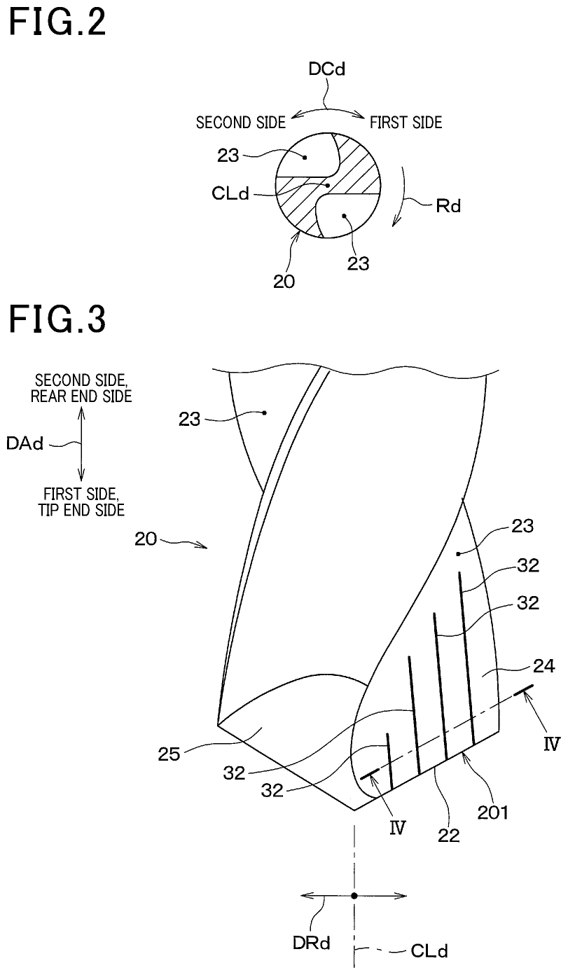

In the following explanation of the present embodiment, the axial direction DAd of the drill axial center CLd will be referred to as the drill axial direction DAd, and a radial direction DRd of the drill axial direction CLd will be referred to as the drill radial direction DRd. FIG. 2 shows a circumferential direction DCd around the drill axial center CLd. The circumferential direction DCd of the drill axial center CLd will be referred to as the drill circumferential direction DCd. For confirmation, the drill axial direction DAd of the drill axial center CLd corresponds to the axial direction of the drill 10, and the drill radial direction DRd of the drill axial center CLd corresponds to the radial direction of the drill 10. The drill circumferential direction DCd of the drill axial center CLd corresponds to the circumferential direction of the drill 10.

The arrow mark Rd shown in FIG. 1 and FIG. 2 indicates the turning direction Rd of the drill 10 during the process of drilling a workpiece. An angle a represents a helix angle of the chip discharge flute 23. A part of the drill axial direction DAd of the drill main body 20 is omitted from FIG. 1. A plurality of guide grooves 32 (see FIG. 3) are also omitted from FIG. 1 for brevity. The plurality of guide grooves 32 correspond to ground grooves 32.

The shank 21 has a shape extending along the drill axial direction DAd. The shank 21 is fixed to a holder of a drill machining device which rotates the drill 10. The rotational force of the drill machining device is transmitted to the shank 21 through the holder. As shown in FIG. 1 and FIG. 2, the drill 10 rotates around the drill axial center CLd in the rotation direction designated by the arrow Rd. That is, the drill 10 rotates in a first side of the drill circumferential direction DCd shown in FIG. 2 during a cutting process of a workpiece. In other words, during a cutting process, the drill 10 rotates clockwise along the drill axial direction DAd from the view of a rear end side of the drill main body 20 toward the tip end 201 side.

The drill main body 20 cuts a workpiece to form a cut hole, and discharges chips generated in the cutting process from the cut hole of the workpiece. As shown in FIG. 1 and FIG. 3, the drill main body 20 has the side 201 at the first side of the drill axis direction DAd. The drill main body 20 has a cutting blade 22 and chip discharge flutes 23. The cutting blade 22 is formed at the tip end 201 side of the drill main body 20. The chip discharge flute 23 is formed in helical shape extending from the tip end 201 side toward the rear end side of the drill main body 20.

A rake surface 24 is formed facing the chip discharge flute 23 at the tip end 201 side of the drill main body 20 extending from the cutting blade 22 side along the chip discharge flute 23.

In more detail, a pair of the cutting blades 22 are formed around the drill axial center CLd. Similarly, a pair of the chip discharge flutes 23 and a pair of the rake surfaces 24 are formed around the drill axial center CLd.

As shown in FIG. 1 to FIG. 3, because the chip discharge flutes 23 are formed in recess shape on the outer circumferential surface of the drill main body 20, the chip discharge flutes 23 are formed opening toward the drill radial outward direction DRd. The chip discharge flutes 23 discharge chips from the cutting hole externally, generated by the cutting blades 22 in the cutting process.

As previously described, the chip discharge flute 23 has a helical shape. In more detail, the chip discharge flute 23 is formed in helical shape turning in the first side around the drill circumferential direction DCd of the drill axial center CLd toward the tip end 201 side from the rear end side of the drill main body 20. In further detail, the chip discharge flutes 23 have a helical shape curved clockwise from the rear end toward the tip end 201 side of the drill main body 20. The drill 10 according to the present embodiment is a right twist drill.

An escape surface 25 is formed at the tip end 201 side of the drill main body 20. The escape surface 25 reduces a contact area between the tip end 201 side of the drill main body 20 and the workpiece during the cutting process. This reduces a cutting resistance during the cutting process. The cutting blade 22 is formed on a ridge part between the escape surface 25 and the rake surface 24 at the tip end 201 side of the drill main body 20.

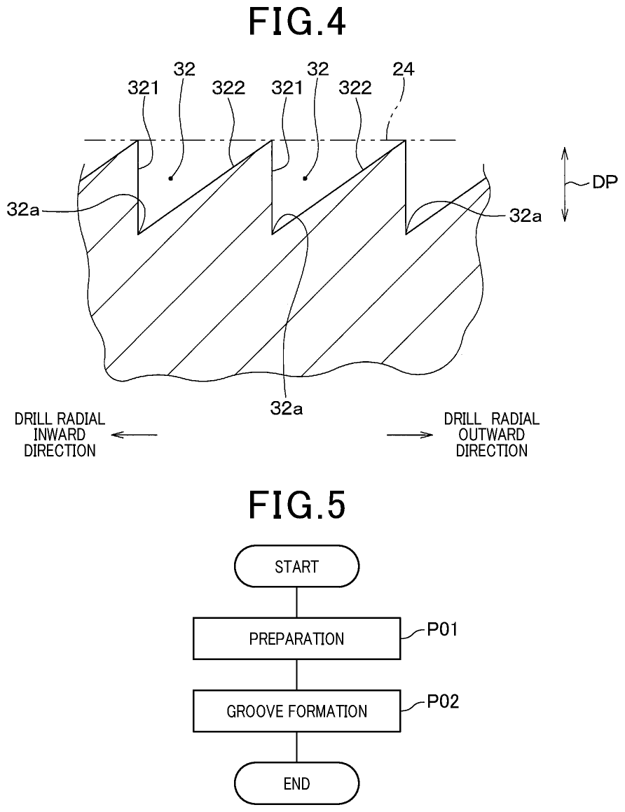

As shown in FIG. 3 and FIG. 4, the plurality of guide grooves 32 are formed as ground grooves by a grinding process on the rake surface 24 of the drill main body 20. As previously described, because the drill 10 has the pair of rake surfaces 24, the plurality of guide grooves 32 are formed on each of the pair of rake surfaces 24.

The guide grooves 32 guide chips during the cutting process. In more detail, the guide grooves 32 prevents chips from being curled during the cutting process. Further, the guide grooves 32 regulate a direction of discharging the chips, and smoothly discharge the chips.

Each of the guide grooves 32 is formed extending in the direction (i.e. in the discharge flute extending direction) toward which the chip discharge flute 23 is extended from the cutting blade 22 toward the rear end side of the drill main body 20. In other words, each of the plurality of guide grooves 32 is formed extending in a helical direction of the chip discharge flute 23 from the cutting blades 22 towards the rear end side of the drill main body 20. In the present embodiment, for example, each of the plurality of guide grooves 32 is extended along the extending direction of the chip discharge flute. This represents that the guide groove 32 is formed extending in the direction equal to, or approximately equal to the extending direction of the chip discharge flute.

The plurality of guide grooves 32 extend in parallel with each other. It is acceptable to form the guide grooves 22 at a regular interval or irregular interval.

The drill main body 20 has the plurality of guide grooves 32 which are formed on the rake surface 24. Each of the plurality of guide grooves 32 has an inner groove wall surface 321 and an outer groove wall surface 322.

The inner groove wall surface 321 of the guide groove 32 is arranged facing the drill radial inward direction DRd. The outer groove wall surface 322 of the guide groove 32 is arranged facing the drill radial outward direction DRd.

In more detail, the guide groove 32 has a V-shape cross section, a groove width thereof which is gradually reduced toward the bottom 32a of the guide groove 32 in a depth direction DP of the guide groove 32. That is, a distance between the inner groove wall surface 321 and the outer groove wall surface 322 is reduced toward the bottom 32a of the guide groove 32.

Further, the outer groove wall surface 322 is a slope which is oblique to the rake surface 24. The inner groove wall surface 321 is a vertical surface to the rake surface 24. Accordingly, the inner groove wall surface 321 is perpendicularly arranged closer to the rake surface 24 than to the outer groove wall surface 322.

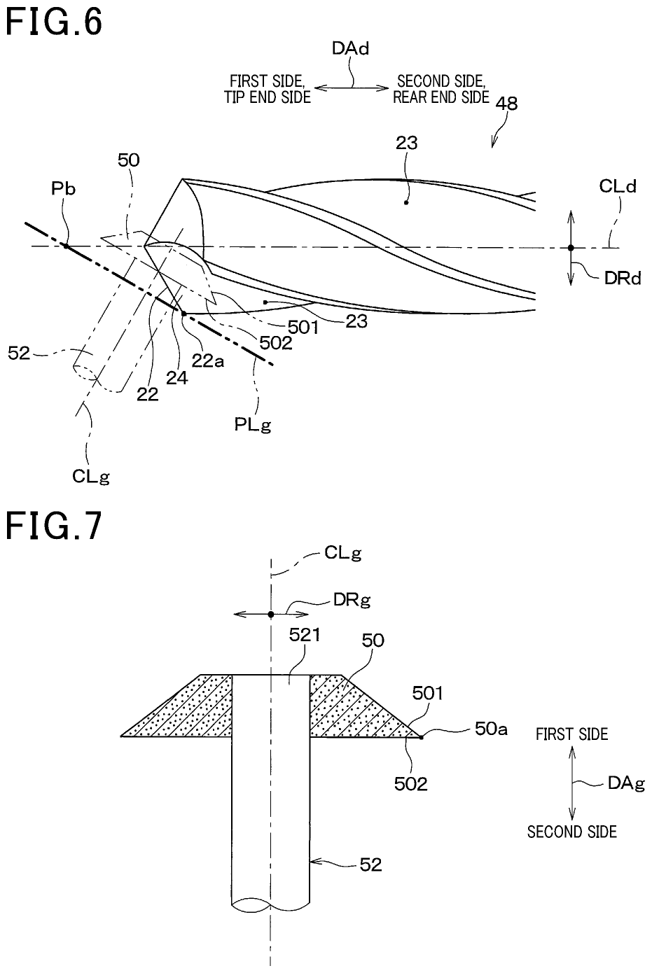

FIG. 5 shows the process of forming the plurality of guide grooves 32 on the rake surface 24 of the drill 10. That is, FIG. 5 shows the process of producing the drill 10 with the plurality of guide grooves 32. In FIG. 5, a preparation step P01 prepares a workpiece 48. The workpiece 48 is processed to produce the drill 10 having the plurality of guide grooves 32. As shown in FIG. 1 and FIG. 6, the cutting blades 22, the chip discharge flutes 23, the rake surfaces 24 and the escape surfaces 25 have been formed on the workpiece 48. The drill 10 has the plurality of guide grooves 32. For example, the workpiece 48 without the plurality of guide grooves 32 is prepared. After the preparation step P01, the method according to the present disclosure progresses to a groove formation step P02.

FIG. 6 shows the workpiece 48 and a rotary whetstone 50, viewed from the upper side of the rake surface 24 as a grinding target to the rake surface 24 along a normal direction of a surface parallel to the drill axial center CLd and a rotary whetstone axial center CLg. Accordingly, FIG. 6 shows an intersection angle of the drill axial center CLd and the rotary whetstone axial center CLg generated on a virtual plane surface when the drill axial center CLd and the rotary whetstone axial center CLg are projected toward the virtual plane surface parallel with the drill axial center CLd and the rotary whetstone axial center CLg.

The groove formation step P02 shown in FIG. 5 grinds the rake surface 24 to form the plurality of guide grooves 32 by using the rotary whetstone 50 which is rotating around the rotary whetstone axial center CLg. That is, the groove formation step P02 forms the plurality of guide grooves 32 on the rake surface 24.

In the groove formation step P02 shown in FIG. 6 and FIG. 7, a drive motor (not shown) rotates a whetstone rotary axis 52 of the rotary whetstone 50 around the rotary whetstone axial center CLg. This whetstone rotary axis 52 extends along an axial direction DAg of the rotary whetstone axial center CLg, and has a tip end 521 at one end side of the axial direction DAg. The rotary whetstone 50 is fixed at the tip end 521 to the whetstone rotary axis 52.

In the groove formation step P02, the rotary whetstone axial center CLg of the rotary whetstone 50 is arranged to intersect a longitudinal direction of the guide groove 32 (see FIG. 3).

In more detail, FIG. 6 shows an intersection point Pb between the virtual plane surface PLg and the drill axial center CLd. The virtual plane surface PLg passes through the outer circumferential end position 22a of the cutting blade 22, and is orthogonal to the rotary whetstone axial center CLg. The cutting blade 22 is in contact with the rake surface 24 to be ground in the groove formation step P02. Further, in the groove formation step P02, the rotary whetstone axial center CLg of the rotary whetstone 50 is arranged which is oblique to the drill axial center CLd so that the cutting blade 22, to be in contact with the rake surface 24, is arranged closer to a rear end side of the drill main body 20 than to the intersection point Pb.

In other words, the virtual plane surface PLg is arranged which is rotationally offset relative to the drill axial center CLd so as to make an acute angle in the direction shown in FIG. 6.

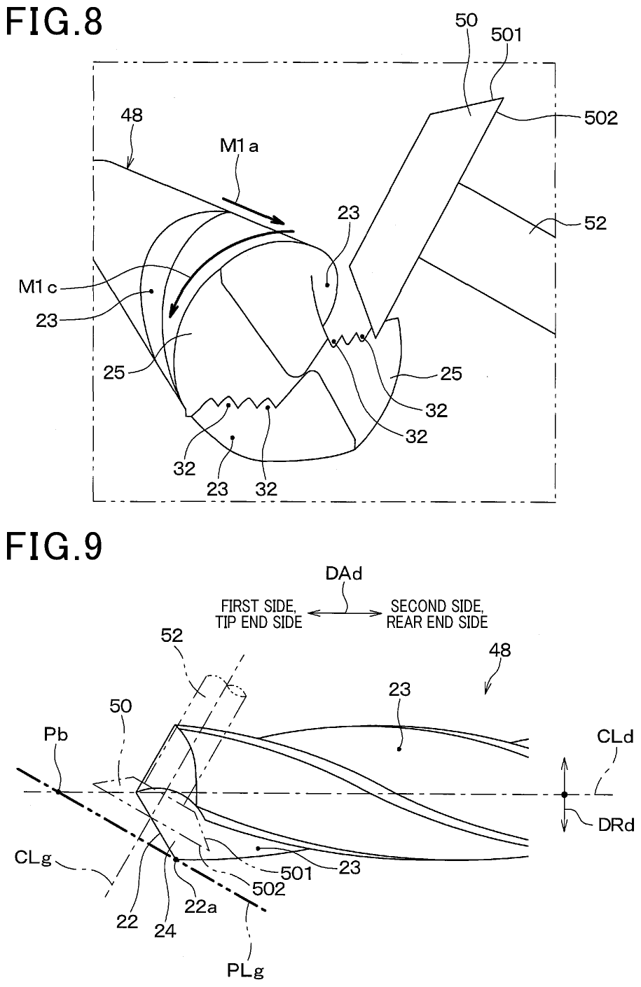

In the present embodiment, as shown in FIG. 6 and FIG. 8, the rotary whetstone 50 is arranged to the workpiece 48 under the situation previously described, and the position of the workpiece 48 is adjusted so as to form the plurality of guide grooves 32. That is, a grinding process device, not shown, performing the grinding process of the drill 10 moves the rotating workpiece 48 while the rotating rotary whetstone 50 is fixed.

Specifically, the workpiece 48 is rotated relatively with respect to the position of the rotating rotary whetstone 50, in the first side of the drill circumferential direction DCd (see FIG. 2) designated by the arrow M1c. The workpiece 48 is moved toward the first side of the drill axial direction DAd designated by the arrow M1a. That is, the workpiece 48 is moved toward both the drill circumferential direction DCd and the axial direction DAd depending on the direction of twist of the chip discharge flutes 23. The rotary whetstone 50 is moved along the chip discharge flutes 23, relatively with respect to the location of the workpiece 48. The guide grooves 32 are formed from the tip end 201 side to the rear end side of the drill main body 20 while the workpiece 48 is rotated and moved.

As shown in FIG. 6 and FIG. 7, the rotary whetstone 50, to be used in the groove formation step P02, has a rotating body shape projecting in a radial outward direction DRg of the rotary whetstone axial center CLg and around the rotary whetstone axial center CLg. It is acceptable for the rotary whetstone 50 to have the projecting shape without a rounded corner, i.e., sufficient to have a usable projecting tip.

Specifically, the rotary whetstone 50 has a primary whetstone surface 501 and a secondary whetstone surface 502. In the present embodiment, the primary whetstone surface 501 is arranged at the first side, and the secondary whetstone surface 502 is arranged at the second side of the axial direction DAg of the rotary whetstone axial center CLg.

The primary whetstone surface 501 of the rotary whetstone 50 forms one of two surfaces from a projecting vertex 50a. The primary whetstone surface 501 forms such a rotary shape of the rotary whetstone 50, and has a tapered annular shape extending around the rotary whetstone axial center CLg. The secondary whetstone surface 502 of the rotary whetstone 50 forms the other surface of the projecting vertex 50a, and forms an annular shape extending around the rotary whetstone axial center CLg. Accordingly, the secondary whetstone surface 502 is arranged perpendicularly closer to the rotary whetstone axial center CLg than to the primary whetstone surface 501.

In the groove formation step P02, as shown in FIG. 4 and FIG. 6, the inner groove wall surface 321 of the guide groove 32 is formed by the primary whetstone surface 501, and the outer groove wall surface 322 of the guide groove 32 is formed by the secondary whetstone surface 502. As a result, the guide groove 32 is formed to have a structure in which the more the depth of the guide groove 32 in the depth direction DP approaches the bottom 32a of the guide groove 32, the more a distance between the inner groove wall surface 321 and the outer groove wall surface 322 is reduced. Further, the guide groove 32 is formed so that the inner groove wall surface 321 is arranged perpendicularly closer to the rake surface 24 than to the outer groove wall surface 322.

A description will be given of actions and effects of the present disclosure. A comparative drill will be explained as compared with the drill 10 according to the present embodiment. The comparative drill has a structure without the guide grooves 32. The drill 10 according to the present disclosure and the comparative drill have the same structure except for the formation of the guide groove 32.

The drill cutting process (i.e., when drilling a hole) generates chips that have with up-curl and side-curl. Chips with up-curl are generated by abrasion between the chips and the rake surface 24 around the axis parallel with the cutting blade 22 shown in FIG. 1. Chips that have side-curl are generated, due to a speed difference between an inner radius speed and an outer radius speed of the cutting blade 22, around the normal line of the rake surface 24. In particular, because the cutting blade 22 of the comparative drill extends to the outer diameter from a center position of the drill, such chips that have side-curl have a diameter which is approximately equal to the diameter of the comparative drill. This structure generates chips that have side-curl having a large size. When chips that have up-curl and side-curl are generated, because this generates the curled chips in three dimensions from the cutting blade 22, the generated chips collide with the inner wall of the chip discharge flute 23, and becomes divided. In particular, when a deep hole is formed in a workpiece by using the chip discharge flute 23 having a narrow width, this will cause a possible clogging of chips in the chip discharge flute 23.

On the other hand, as shown in FIG. 3 and FIG. 4, the present disclosure provides the drill having the plurality of guide grooves 32 formed on the rake surface 24 of the drill main body 20. This structure makes it possible for the guide grooves 32 to trap a deformed part of the chips in contact with the rake surface 24 during the cutting process, and the chip trapped by the guide groove 32 is guided in a direction along the guide groove 32. At this time, because the guide groove 32 traps chips that have side-curl, this prevents the chip that has side-curl from growing. Further, because the chip that has up-curl is not arranged in parallel to a generation direction of the chip that has up-curl, this structure presents the chip that has up-curl from curving and growing.

This makes it possible to continuously discharge two-dimensional chips, i.e., chips of a line shape having a large width greater than the width of the guide groove 32 along the guide groove 32 without allowing chips to clog the chip discharge flute 23.

The present disclosure provides the drill having the rake surface 24 with the plurality of guide grooves 32. This structure makes it possible to perform a cutting process without causing clogging of chips in the plurality of guide grooves 32. Further, because the chips are moved along the chip discharge flute 23 without dividing, this makes it possible to increase a drill moving speed within a drill strength range, which directly affects its processing efficiency. Further, because chips having a straight shape without curled has a two-dimensional flat shape, this makes it possible to reduce a cross sectional area of the chip discharge flute 23, and increase the drill strength.

As shown in FIG. 2 to FIG. 6, the present disclosure performs the groove formation step P02 grinds the rake surface 24 by using the rotary whetstone 50 which rotates around the rotary whetstone axial center CLg so as to form the plurality of guide grooves 32 on the rake surface 24. That is, the plurality of guide grooves 32 are formed on the rake surface 24 by the grinding process. This makes it possible to suppress strength reduction of the drill from occurring during the process of grinding the guide grooves 32, as compared with that of a drill with guide grooves formed by using a laser process.

The rotary whetstone 50 used by the groove formation step P02 has a rotary shape obtained by turning a projecting shape in the radial outward direction DRg of the rotary whetstone axial center CLg around the rotary whetstone axial center CLg. Accordingly, when the tip as the outer circumferential edge part of the rotary whetstone 50 is inserted in the inside of the chip discharge flute 23, it is possible to grind the rake surface 24 by using the outer circumferential edge part of the rotary whetstone 50. For example, this grinding process makes it possible to easily avoid physical interference between the rotary whetstone 50 as a processing tool and the workpiece 48 from occurring, as compared with that using a whetstone having a cylindrical shape, not having such a rotary shape.

Further, even when the rotary whetstone 50 of a large diameter having the same shape of the outer circumferential end part is used, this does not increase physical interference between the rotary whetstone 50 and the workpiece 48. The use of the rotary whetstone 50 having the rotary shape used by the present disclosure provides large benefits increasing the lifetime of the rotary whetstone 50, and reducing the processing time of the rotary whetstone 50 and the processing cost.

Further, as shown in FIG. 1, FIG. 6 and FIG. 8, the chip discharge flute 23 is formed helically extending from the tip end 201 side of the drill main body 20 toward the rear end side of the drill main body 20. This helical shape of the chip discharge flute 23 is formed toward the tip end 201 side from the rear end side of the drill main body 20 while turning toward the first side of the circumferential direction DCd (see FIG. 2).

As shown in FIG. 5, the groove formation step P02 moves the workpiece 48 toward the first side in the drill axial direction DAd designated by the arrow M1a, relatively with respect to the position of the rotary whetstone 50 which rotates, while being rotated in the first side of the circumferential direction DCd designated by the arrow M1c. As shown in FIG. 3, this makes it possible to form the guide grooves 32 in the extension direction of the chip discharge flute 23.

According to the present disclosure, as shown in FIG. 4 and FIG. 5, the groove formation step P02 forms the guide grooves 32 so that the inner groove wall surface 321 and the outer groove wall surface 322 become closer to each other to toward the bottom 32a of the guide groove 32 in the depth direction DP. Further, the guide groove 32 is formed so that the inner groove wall surface 321 is perpendicularly closer to the rake surface 24 than to the outer groove wall surface 322. Accordingly, this structure makes it possible to provide the guide grooves 32 that suppressing generation of chips that have side-curl, and regulating the moving direction of the chips when compared with those when the guide groove 32 has a V-shape cross section in which the inner groove wall surface 321 and the outer groove wall surface 322 of the guide groove 32 are oblique to the rake surface 24 at the same angle.

According to the present disclosure, as shown in FIG. 4 to FIG. 7, the primary whetstone surface 501 of the rotary whetstone 50 is an annular tapered surface as one surface of both surfaces annularly extending around the rotary whetstone axial center CLg at the projecting vertex 50a of the rotary whetstone 50 having a rotary shape. The secondary whetstone surface 502 of the rotary whetstone 50 is an annular surface as the other surface annularly extending around the rotary whetstone axial center CLg at the projecting vertex 50a of the rotary whetstone 50. The secondary whetstone surface 502 is arranged perpendicularly closer to the rotary whetstone axial center CLg than to the primary whetstone surface 501. As shown in FIG. 4 and FIG. 6, the groove formation step P02 forms the inner groove wall surface 321 of the guide groove 32 by using the primary whetstone surface 501, and forms the outer groove wall surface 322 of the guide groove 32 by using the secondary whetstone surface 502.

This process makes it possible to arrange the rotary whetstone axial center CLg which is oblique to the rake surface 24 while avoiding the occurrence of interference between the rotary whetstone 50 and a part of the workpiece 48 around the chip discharge flute 23 of the drill 10. Accordingly, it is possible to form the guide groove 32 effectively suppressing chips that have side-curl from being generated, and to easily avoid the occurrence of physical interference between the rotary whetstone 50 and the workpiece 48.

According to the present disclosure, as shown in FIG. 5 and FIG. 6, the groove formation step P02 uses the intersection point Pb where the virtual plane surface PLg and the drill axial center CLd intersect, where the virtual plane surface PLg passes through the outer circumferential end position 22a of the cutting blade 22 and is orthogonal to the rotary whetstone axial center CLg, and the cutting blade 22 is in contact with the rake surface 24 which is ground during the groove formation step P02. The groove formation step P02 arranges the rotary whetstone axial center CLg of the rotary whetstone 50 which is oblique to with respect to the drill axial center CLd so that the cutting blade 22 in contact with the rake surface 24 to be ground is arranged closer to the rear end side of the drill main body 20 than to the intersection point Pb. Accordingly, the rotary whetstone 50 is arranged in the direction, along which the guide grooves 32 are formed, extending the chip discharge flute 23, this makes it possible to easily avoid physical interference between the rotary whetstone 50 and the workpiece 48 from occurring as compared with a case when the rotary whetstone 50 is not arranged in this direction.

### Second Embodiment

A description will be given of the second embodiment. A difference between the second embodiment and the first embodiment previously described will be explained. The same component between the second embodiment and the first embodiment will be referred to as the same reference numbers and characters. This matter will be used for other embodiments which will be explained later.

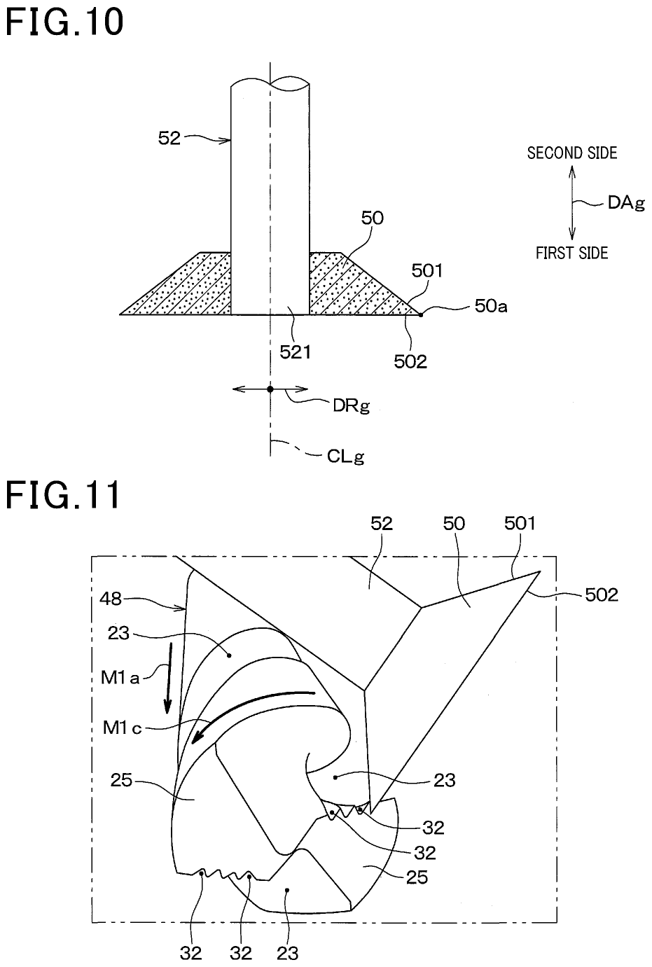

As shown in FIG. 9 to FIG. 11, similar to the first embodiment, the whetstone rotary axis 52 has the tip end 521 at a first side of the axial direction DAg of the rotary whetstone axial center CLg. However, in the second embodiment, the rotary whetstone 50, viewed from the whetstone rotary axis 52, is arranged in the direction which is opposite to the arrangement of the rotary whetstone 50 in the first embodiment.

Specifically, the primary whetstone surface 501 is located at the second side of the axial direction DAg of the rotary whetstone axial center CLg of the rotary whetstone 50, which is opposite to the first side where the secondary whetstone surface 502 is arranged. Accordingly, in the groove formation step P02 shown in FIG. 5, the whetstone rotary axis 52 is located at the position opposite to that in the first embodiment, viewed from the workpiece 48 side, during the grinding process of the workpiece 48 by using the rotary whetstone 50.

As can be understood when the second embodiment shown in FIG. 11 is compared with the first embodiment shown in FIG. 8, the first embodiment and the second embodiment use the same moving direction of the workpiece 48 as designated by the arrow M1a and the arrow M1c.

The present embodiment and the first embodiment perform the same process, except for the features previously described. The same components between the present embodiment and the first embodiment provide the same effects.

### Third Embodiment

A description will be given of the third embodiment. A difference between the third embodiment and the first embodiment previously described will be mainly explained.

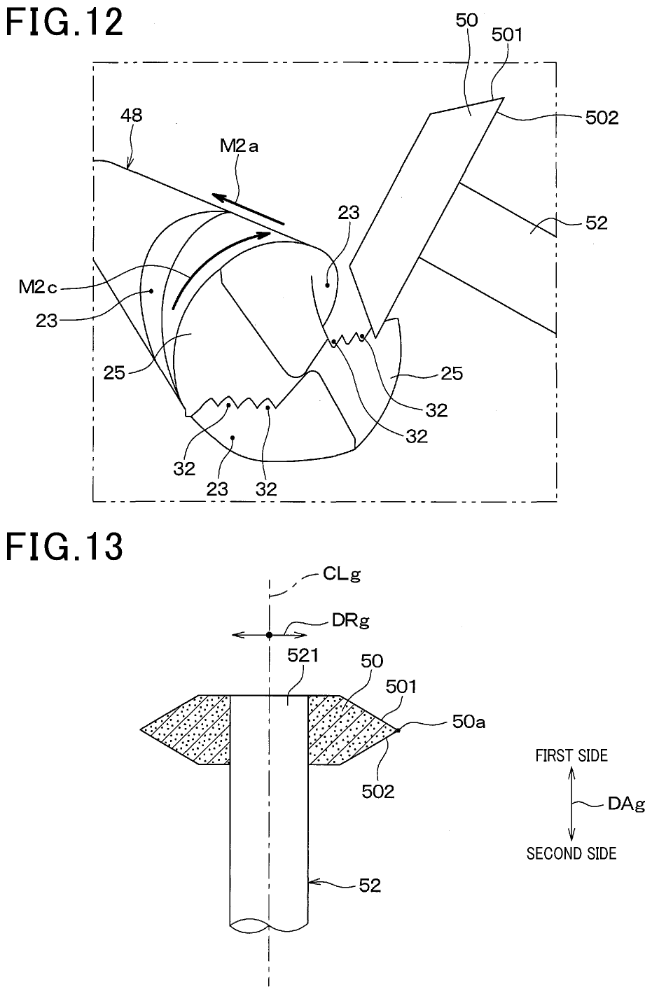

As designated by the arrow M2a and the arrow M2c shown in FIG. 12, the groove formation step P02 according to the present embodiment moves the workpiece 48 in a moving direction which is opposite to the moving direction used by the first embodiment.

Specifically, the workpiece 48 is moved toward the second side of the drill axial direction DAd, designated by the arrow M2a, while being rotated in the second side of the circumferential direction DCd (see FIG. 2) designated by the arrow M2c, relatively with respect to the position of the rotary whetstone 50 which rotates. The guide groove 32 is formed from the rear end side toward the tip end 201 side of the drill main body 20. Similar to the first embodiment, this makes it possible to form the guide groove 32 so that the guide groove 32 extends toward the extending direction (see FIG. 3) of the chip discharge flute 23.

The present embodiment and the first embodiment perform the same process, except for the features previously described. The same components between the present embodiment and the first embodiment provide the same effects.

The present embodiment is one of the modifications of the first embodiments. It is acceptable to apply the moving direction of the workpiece 48 used in the present embodiment to the second embodiment.

### Other Modifications

(1) As shown in FIG. 1, each of the embodiments previously described uses the drill 10 of a right-hand helix twist type. The concept of the present disclosure is not limited to this. It is acceptable for each of the embodiments to use the drill 10 of a left-hand helix twist type. In the drill 10 of a left-hand helix twist type, the chip discharge flute 23 has a helically twisted shape counterclockwise extending from the rear end side toward the tip end 201 side of the drill main body 20.

When the drill 10 of a left-hand helix twist type is used, in the groove formation step P02 shown in FIG. 5, the positional relationship between the workpiece 48 and the rotary whetstone 50 during the grinding process of the rake surface 24 is reversed, viewed from the drill axial center CLd, to that shown in FIG. 6. Accordingly, when the rake surface 24 on the workpiece 48 is viewed along the direction of the normal line of a plane surface parallel with both the drill axial center CLd and the rotary whetstone axial center CLg, the arrangement of the rotary whetstone 50 against the workpiece 48 is as follows. That is, the virtual plane surface PLg (see FIG. 6) in the viewed direction previously described is tilted counterclockwise to the drill axial center CLd to have a sharp tilted angle.
(2) As shown in FIG. 3, in each of the embodiments previously described, because each of the plurality of guide grooves 32 is formed extending from the cutting blade 22 toward the rear end side of the drill main body 20, each of the plurality of guide grooves 32 is in contact with the cutting blade 22. However, the concept of the present disclosure is not limited by this. For example, it is acceptable for each of the plurality of guide grooves 32 not to be in contact with the cutting blade 22, and acceptable to form a small gap between the cutting blade 22 and each of the plurality of guide grooves 32.
(3) As shown in FIG. 3, in each of the embodiments previously described, each of the plurality of guide grooves 32 is formed along the extending direction of the chip discharge flute 23. This structure is one of various modifications of the present disclosure. It is acceptable to form each of the plurality of guide grooves 32 to be slightly tilted to the extending direction of the chip discharge flute 23 so long as each of the plurality of guide grooves 32 to be extended toward the extending direction of the chip discharge flute 23.
(4) As shown in FIG. 3, in each of the embodiments previously described, the plurality of guide grooves 32 are formed parallel with each other. However, the concept of the present disclosure is not limited by this. It is acceptable for each of the plurality of guide grooves 32 to be formed not in parallel with each other.
(5) As shown in FIG. 3, in each of the embodiments previously described, the plurality of guide grooves 32 are formed on the rake surface 24. However, the concept of the present disclosure is not limited by this. It is acceptable to form one guide groove 32 on the rake surface 24.
(6) As shown in FIG. 4, in each of the embodiments previously described, the inner groove wall surface 321 is perpendicularly arranged to the rake surface 24. However, the concept of the present disclosure is not limited by this. It is acceptable to form the inner groove wall surface 321 which is slightly tilted to the rake surface 24.
(7) In the cross section of the guide grooves 32 shown in FIG. 4 in each of the embodiments previously described, the inner groove wall surface 321 and the outer groove wall surface 322 have a straight shape. However, the concept of the present disclosure is not limited by this. It is acceptable for each of the inner groove wall surface 321 and the outer groove wall surface 322 on the cross section of the guide grooves 32 to have a curved shape.
(8) As shown in FIG. 7, in each of the embodiments previously described, the secondary whetstone surface 502 of the rotary whetstone 50 is formed to have a vertical surface to the rotary whetstone axial center CLg. However, the concept of the present disclosure is not limited by this. It is acceptable to form the secondary whetstone surface 502 having a tapered surface on a cross section of the guide groove to be formed by the rotary whetstone 50. For example, as shown in FIG. 13, it is acceptable for both the primary whetstone surface 501 and the secondary whetstone surface 502 of the rotary whetstone 50 to have a tapered surface.
(9) For example, on forming the guide grooves 32, shown in FIG. 8 in each of the embodiments previously described, the workpiece 48 is moved while the position of the rotating rotary whetstone 50 is fixed. However, the concept of the present disclosure is not limited by this. It is acceptable to move the rotary whetstone 50 while the workpiece 48 is fixed. It is also acceptable to move both the rotary whetstone 50 and the workpiece 48.
(10) The concept of the present disclosure is not limited by the embodiments previously described. It is acceptable for the present disclosure to have various modifications. It is possible to combine each of the embodiments previously described if possible.
(11) While each of the embodiments of the present disclosure has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present disclosure which is to be given the full breadth of the following claims and all equivalents thereof.

In each of the embodiments, the components are limited by material, shape, positional relationship thereof, etc. are not limited, so long as those have specific material, shape, positional relationship, etc.

According to a first aspect of the present disclosure disclosed in each of the embodiments or a part of the embodiments previously described, a rake surface of a workpiece is ground by using a rotary whetstone which rotates around a rotary whetstone axial center of the rotary whetstone after the preparation of the workpiece. This forms guide grooves on the rake surface extending in an extending direction of a chip discharge flute of the workpiece. In the groove formation step, the rotary whetstone axial center of the rotary whetstone is arranged to cross a longitudinal direction of the guide grooves. The groove formation step uses the rotary whetstone having a rotating body shape projecting in a radial outward direction of the rotary whetstone axial center and around the rotary whetstone axial center.

According to a second aspect of the present disclosure, the chip discharge flute is formed in helical shape turning in the first side around the drill circumferential direction of the drill axial center toward the tip end side from the rear end side of the drill main body. In the groove formation step, the workpiece is rotated, relatively with respect to the position of the rotary whetstone, in the first side of the drill circumferential direction. This makes it possible to form the guide grooves extending in the extending direction of the chip discharge flute.

According to a third aspect of the present disclosure, in the groove formation step, the workpiece is moved to the opposite to the drill axial direction, relatively with respect to the location of the rotary whetstone which rotates, while the workpiece is rotated in the second side of the circumferential direction. This also makes it possible to form the guide grooves extending in the extending direction of the chip discharge flute.

According to a fourth aspect of the present disclosure, the guide groove is formed to have the inner groove wall surface and the outer groove wall surface formed on the rake surface. The inner groove wall surface of the guide groove is arranged facing the drill radial inward direction. The outer groove wall surface of the guide groove is arranged facing the drill radial outward direction. The groove formation step forms the guide groove so that a distance between the inner groove wall surface and the outer groove wall surface is reduced toward the bottom of the guide groove, and the inner groove wall surface is perpendicularly arranged closer to the rake surface than to the position of the outer groove wall surface. Accordingly, for example, this structure makes it possible to provide the guide grooves capable of effectively suppressing chips that have side-curl from being generated, and of regulating the moving direction of the chips as compared with a case when the guide groove has a V-shape cross section where the inner groove wall surface and the outer groove wall surface of the guide groove are tilted to the rake surface at the same angle.

According to a fifth aspect of the present disclosure, the rotary whetstone has the primary whetstone surface and the secondary whetstone surface. The primary whetstone surface forms one surface in two surfaces at a projecting vertex, viewed from the projecting vertex of the projected rotating body shape of the rotary main body. The primary whetstone surface has a tapered annular shape extending around the rotary whetstone axial center. The secondary whetstone surface forms the other surface from the projecting vertex, and has an annular shape extending around the rotary whetstone axial center. The secondary whetstone surface is perpendicularly arranged closer to the rotary whetstone axial center than to the primary whetstone surface. In the groove formation step, the inner groove wall surface of the guide groove is formed by the primary whetstone surface, and the outer groove wall surface of the guide groove is formed by the secondary whetstone surface. This process makes it possible to arrange the rotary whetstone axial center which is oblique to the rake surface so as to avoid interference of the rotary whetstone from occurring to a part of the workpiece around the chip discharge flute of the workpiece as a drill. It is possible to form the guide groove while effectively suppressing chips due to sideways curling from being generated, and to easily avoid physical interference between the rotary whetstone and the workpiece from occurring.

According to a sixth aspect of the present disclosure, the secondary whetstone surface is arranged perpendicularly closer to the rotary whetstone axial center.

According to a seventh aspect of the present disclosure, the groove formation step arranges the rotary whetstone so that the rotary whetstone axial center of the rotary whetstone is tilted to the drill axial center and the cutting blade is arranged closer to the rear end side of the drill main body than to a predetermined intersection point. This predetermined intersection point represents an intersection of a virtual plane surface and the drill axial center CLd. The virtual plane surface passes through the outer circumferential end position of the cutting blade and is orthogonal to the rotary whetstone axial center, and the cutting blade is arranged to be in contact with the rake surface to be ground at the rear end side of the drill main body. Accordingly, the rotary whetstone is arranged in the direction, along which the guide grooves are formed, extending along the chip discharge flute, this makes it possible to easily avoid physical interference between the rotary whetstone and the workpiece from occurring as compared with a case when the rotary whetstone is not arranged in this direction.

As previously described in detail, the present disclosure provides the method of producing a drill. The method forms a guide groove on a rake surface of a drill while easily avoiding physical interference between the drill and a processing tool from occurring, and suppressing strength reduction of the drill of occurring during a guide groove formation, as compared with a method using a laser machining process.

As previously described, because the ground groove is formed on the rake surface by grinding the rake surface, this makes it possible to suppress the reduction in strength of the drill during the process from occurring during the process of grinding the rake surface, as compared with a case by using a laser process of forming such a ground groove.

Because the rotary whetstone, as a processing tool, has a rotating body shape projecting in the radial outward direction of the rotary whetstone axial center, and around the rotary whetstone axial center. The rotary whetstone has a rotary shape, which rotates around the rotary whetstone axial center. This structure makes it possible to insert the outer circumferential end of the rotary whetstone in the inside of the chip discharge flute. It is possible for the outer circumferential end of the rotary whetstone to grind the rake surface. Accordingly, it is possible to easily avoid physical interference between the rotary whetstone and the workpiece from occurring, as compared with a process using a whetstone having a cylindrical shape, not having such a rotary shape.

What is claimed is:

1. A method of producing a drill, the drill comprising a drill main body, the drill main body comprising a chip discharge flute, a rake surface and a cutting blade, a tip end being formed at the first side of an axial direction of a drill axial center of the drill main body, the drill being rotated around the drill axial center, the drill main body being formed extending in a direction of the axial direction, the cutting blade being formed at the tip end side of the drill main body, the chip discharge flute having a helical shape formed on the drill main body and helically extending from the tip end side of the drill main body toward a rear end side of the drill main body, and the rake surface being formed facing the chip discharge flute at the tip end side of the drill main body and extending from the cutting blade along the chip discharge flute,
the method comprising steps of:
preparing a workpiece, to be processed to produce the drill, on which the cutting blade, the chip discharge flute and the rake surface have been formed; and
forming a ground groove on the rake surface by grinding the rake surface, in a direction extending along the chip discharge flute by using a rotary whetstone turning around a rotary whetstone axial center thereof,
wherein in the groove formation step, the rotary whetstone axial center of the rotary whetstone is arranged to intersect a longitudinal direction of the ground groove, and the rotary whetstone has a rotating body shape projecting in a radial outward direction of the rotary whetstone axial center and around the rotary whetstone axial center.

2. The method of producing a drill according to claim 1, wherein
the chip discharge flute has a helical shape turning in a first side of a drill circumferential direction of the drill axial center toward the tip end side from the rear end side of the drill main body, and
the groove formation step moves the workpiece toward a first side of the axial direction while rotating the workpiece, relatively with respect to a location of the rotary whetstone, in the first side of the drill circumferential direction.

3. The method of producing a drill according to claim 1, wherein
the chip discharge flute has a helical shape turning in a first side of a drill circumferential direction of the drill axial center toward the tip end side from the rear end side of the drill main body, and
the groove formation step moves the workpiece toward a second side which is opposite to the first side of the axial direction while rotating the workpiece, relatively with respect to a location of the rotary whetstone, in the other direction of the drill circumferential direction.

4. The method of producing a drill according to claim 1, wherein
the groove formation step forms the guide groove having an inner groove wall surface and an outer groove wall surface, where the inner groove wall surface of the guide groove is arranged facing the drill radial inward direction of the drill axial center, and the outer groove wall surface of the guide groove is arranged facing the drill radial outward direction, and the groove formation step forms the guide groove so that a distance between the inner groove wall surface and the outer groove wall surface is reduced toward a bottom of the guide groove, and the inner groove wall surface is arranged perpendicularly closer to the rake surface than to the position of the outer groove wall surface.

5. The method of producing a drill according to claim 4, wherein
the rotary whetstone has a primary whetstone surface and a secondary whetstone surface, the primary whetstone surface forms one surface in two surfaces, viewed from a projecting vertex of the projected rotating body shape and a tapered annular shape extending around the rotary whetstone axial center, the secondary whetstone surface forms the other surface and has an annular shape extending around the rotary whetstone axial center, and is arranged perpendicularly closer to the rotary whetstone axial center than to the primary whetstone surface, and in the groove formation step, the inner groove wall surface of the guide groove is formed by the primary whetstone surface, and the outer groove wall surface of the guide groove is formed by the secondary whetstone surface.

6. The method of producing a drill according to claim 5, wherein
the secondary whetstone surface is arranged perpendicularly closer to the rotary whetstone axial center.

7. The method of producing a drill according to claim 1, wherein
the groove formation step arranges the rotary whetstone axial center of the rotary whetstone which is oblique to with respect to the drill axial center so that the cutting blade in contact with the rake surface to be ground is arranged closer to the rear end side of the drill main body than to an intersection point, where the intersection point indicates an intersection of a virtual plane surface and the drill axial center, the virtual plane surface passing through an outer circumferential end position of the cutting blade and being orthogonal to the rotary whetstone axial center.
